(19) United States
(12) Patent Application Publication
(10) Pub. No.: US 2015/0082330 A1
(43) Pub. Date: Mar. 19, 2015

(54) REAL-TIME CHANNEL PROGRAM RECOMMENDATION ON A DISPLAY DEVICE

(71) Applicant: QUALCOMM Incorporated, San Diego, CA (US)

(72) Inventors: Sungrack Yun, Seongnam (KR); Minho Jin, Anyang (KR); Yongwoo Cho, Seoul (KR); Taesu Kim, Seongnam (KR)

(73) Assignee: QUALCOMM Incorporated, San Diego, CA (US)

(21) Appl. No.: 14/030,465

(22) Filed: Sep. 18, 2013

(51) Int. Cl. H04N 21/25; H04N 21/258; H04N 21/266; H04N 21/466; H04N 21/44; H04N 21/4415; H04N 21/45; H04N 21/234; H04N 21/439

(52) U.S. Cl. CPC H04N 21/251; H04N 21/23418; H04N 21/25891; H04N 21/26603; H04N 21/4394; H04N 21/44008; H04N 21/4415; H04N 21/4532; H04N 21/4668
USPC 725/14; 725/40; 725/18

(57) ABSTRACT

A method of providing a channel program recommendation in real-time for a display device is disclosed. The method includes receiving a plurality of multimedia signal streams for a plurality of channel programs, and generating in real-time at least one video and audio content tag based on at least one of video and audio contents from the multimedia signal streams. The display device generates the channel program recommendation including at least one of the channel programs based on the at least one video and audio content tag and at least one of a plurality of viewing criteria. A notification of the channel program recommendation is then output.

### TECHNICAL FIELD

The present disclosure relates to providing channel program recommendations, and more specifically, to providing real-time program recommendations for a plurality of channel programs in an electronic device.

### BACKGROUND

Modern entertainment systems such as televisions, video-on-demand systems, etc., provide a wide variety of channels for viewers. In such systems, an electronic program guide typically displays program information for the available channels. Such program guide is generally used to search for a desired channel program for viewing.

Conventional program guides generally provide information on channel programs such as a schedule, a title, etc. Based on such channel program information, a viewer may manually select a channel to be displayed for viewing. The viewer may also pre-set some of the channels as favorite channels that can be conveniently accessed to minimize user inputs.

However, such channel program information generally does not provide sufficient information on the contents of the channel programs. Accordingly, the viewer may not be able to determine whether the channel programs may be of sufficient interest based on the channel program information. Further, when a viewer is viewing a particular channel, the viewer may miss other channel programs that may be of interest since the conventional program guides are manually accessed.

### SUMMARY

The present disclosure relates to providing real-time program recommendations for a plurality of channel programs in an electronic device based on video and audio content tags and viewing criteria of a viewer.

According to one aspect of the present disclosure, a method of providing a channel program recommendation in real-time for a display device is disclosed. The method includes receiving a plurality of multimedia signal streams for a plurality of channel programs, and generating in real-time at least one video and audio content tag based on at least one of video and audio contents from the multimedia signal streams. The display device generates the channel program recommendation. The channel program recommendation includes at least one of the channel programs based on the at least one video and audio content tag and at least one of a plurality of viewing criteria. A notification of the channel program recommendation is then output. This disclosure also describes apparatus, a device, a server, a system, a combination of means, and a computer-readable medium relating to this method.

According to another aspect of the present disclosure, a system for providing a channel program recommendation in real-time is disclosed. The system includes a server configured to receive multimedia signal streams and generate in real-time at least one video and audio content tag based on at least one of video and audio contents of a plurality of channel programs from the multimedia signal streams and a display device configured to generate the channel program recommendation. The channel program recommendation includes at least one of the channel programs based on the at least one of video and audio contents received from the server and at least one of a plurality of viewing criteria.

According to still another aspect of the present disclosure, a display device for providing a channel program recommendation is disclosed. The display device includes a channel program recommendation unit configured to receive at least one video and audio content tag of a plurality of channel programs from a server and generate the channel program recommendation including at least one of the channel programs based on the at least one video and audio content tag and at least one of a plurality of viewing criteria. The display device also includes a display unit configured to output a notification of the channel program recommendation.

According to yet another aspect of the present disclosure, a server for providing at least one video and audio content tag for a plurality of channel programs to a display device is disclosed. The server includes a receiving unit configured to receive a plurality of multimedia signal streams for the plurality of channel programs, and a channel analysis unit configured to generate in real-time at least one video and audio content tag based on at least one of video and audio contents from the multimedia signal streams, and to output the at least one video and audio content tag to the display device.

### BRIEF DESCRIPTION OF THE DRAWINGS

Embodiments of the inventive aspects of this disclosure will be understood with reference to the following detailed description, when read in conjunction with the accompanying drawings.

FIG. 1 illustrates a system in which a server generates video and audio content tags for a plurality of channels received from a content provider and transmits the video and audio content tags to a plurality of display devices for providing channel program recommendations according to one embodiment of the present disclosure.

FIG. 2 depicts a system including a server and a display device for generating a channel program recommendation according to one embodiment of the present disclosure.

FIG. 3 shows a display device configured to generate video and audio content tags for a plurality of channel programs and output a notification of a channel program recommendation according to another embodiment of the present disclosure.

FIG. 4 is a recommendation window displaying an exemplary channel program recommendation of an exciting event on a display device according to one embodiment of the present disclosure.

FIG. 5 illustrates a recommendation window displaying an exemplary channel program recommendation of a channel program outputting classical music on a display device according to one embodiment of the present disclosure.

FIG. 6 shows a recommendation window displaying an exemplary channel program recommendation of a channel program including a singer singing a song on a display device according to one embodiment of the present disclosure.

FIG. 7 is a recommendation window displaying an exemplary channel program recommendation of a channel program including actors on a display device according to one embodiment of the present disclosure.

FIG. 8 illustrates updating a picture-in-picture window, which displays a channel program recommendation, with a new channel program recommendation after a predetermined period of time according to one embodiment of the present disclosure.

FIG. 9 is a flow chart illustrating a method of providing a notification of a channel program recommendation in real-time for a display device according to one embodiment of the present disclosure.

FIG. 10 depicts a block diagram of a channel analysis unit configured to receive and analyze video and audio contents of the channel programs in multimedia signal streams to generate video and audio content tags according to one embodiment of the present disclosure.

FIG. 11 illustrates generating, in the channel analysis unit, video and audio content tags for a plurality of channels according to one embodiment of the present disclosure.

FIG. 12 shows a block diagram of a channel program recommendation unit of a display device that is configured to generate a channel program recommendation according to one embodiment of the present disclosure.

FIG. 13 shows a diagram illustrating a viewer inputting his or her viewing preferences on a display device for use in prioritizing a channel program recommendation according to one embodiment of the present disclosure.

FIG. 14 is a flow chart illustrating a method performed by the channel program recommendation unit for generating a channel program recommendation according to one embodiment of the present disclosure.

FIG. 15 illustrates comparing a video and audio content tag for a channel program with viewing criteria in the channel program recommendation unit for determining whether to recommend the channel program according to one embodiment of the present disclosure.

FIG. 16 illustrates comparing video and audio content tags of two channel programs with viewing criteria and displaying a prioritized channel program recommendation according to one embodiment of the present disclosure.

FIG. 17 illustrates a diagram of a display device that transmits a notification of a channel recommendation to an external device of a viewer when the viewer is determined not to be within a viewable area of the display device according to one embodiment of the present disclosure.

FIG. 18 is a block diagram of an exemplary mobile device in which the methods and apparatus for generating a channel program recommendation of the present disclosure may be implemented according to some embodiments of the present disclosure.

FIG. 19 shows a block diagram illustrating a server system, which may be any one of the servers previously described, for generating video and audio content tags for channel programs implemented in accordance with some embodiments.

### DETAILED DESCRIPTION

Reference will now be made in detail to various embodiments, examples of which are illustrated in the accompanying drawings. In the following detailed description, numerous specific details are set forth in order to provide a thorough understanding of the inventive aspects of this disclosure. However, it will be apparent to one of ordinary skill in the art that the inventive aspects of this disclosure may be practiced without these specific details. In other instances, well-known methods, procedures, systems, and components have not been described in detail so as not to unnecessarily obscure aspects of the various embodiments.

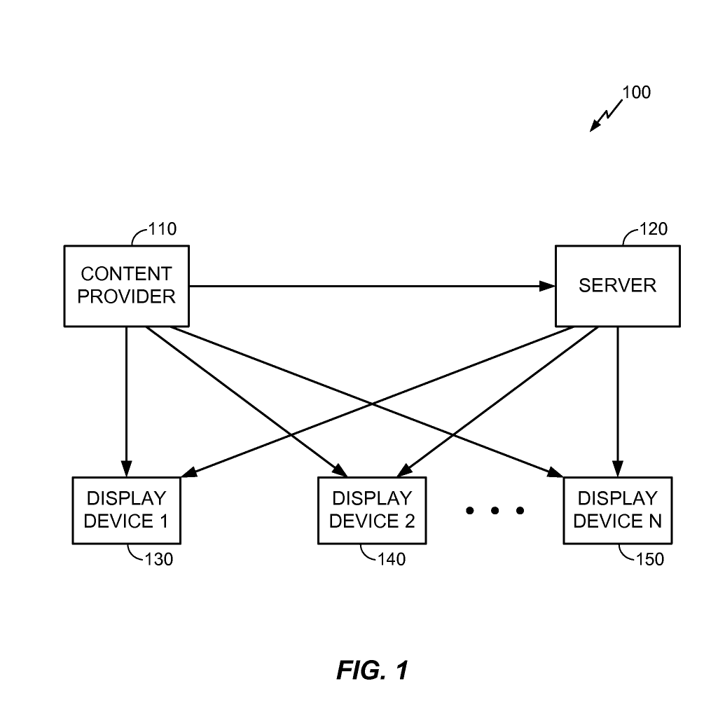

FIG. 1 illustrates a system 100 in which a server 120 generates video and audio content tags for a plurality of channels received from a content provider 110 and transmits the video and audio content tags to a plurality of display devices 130, 140, and 150 for providing channel program recommendations in real-time according to one embodiment of the present disclosure. In the illustrated system 100, the content provider 110 is configured to transmit a plurality of multimedia signal streams, which include video and audio contents, for a plurality of channel programs to the server 120 and the plurality of display devices 130, 140, and 150. The channel programs may include any video and/or audio programs capable of being output on a display device. For example, the channel programs may include programs such as a sporting event, a movie, a drama series, a soundtrack, a music video or performance, a news program, a talk show, a documentary, a reality series, etc.

The server 120 is configured to receive the multimedia signal streams including the video and audio contents for the channel programs from the content provider 110. For each of the channel programs, the server 120 analyzes the video and audio contents and may generate a video and audio content tag for the channel program. The server 120 then transmits the video and audio tags for the channel programs to each of the display devices 130, 140, and 150. The display devices 130, 140 and 150 may be any suitable device capable of receiving and displaying one or more channel programs such as a television, a cellular phone, a smartphone, a laptop computer, a tablet computer, or a personal computer. As used herein, the term “channel program” refers to any viewable programs including TV channel programs, Internet TV channel programs, etc.

The display devices 130, 140, and 150 receive the multimedia signal streams including the channel programs and display one or more channel programs on a display unit of each of the display devices 130, 140, and 150 according to a selection by a viewer. Each of the display devices 130, 140, and 150 is configured to receive the video and audio tags for the channel programs from the server 120 and generate a channel program recommendation based on the content tags and a set of viewing criteria of a viewer of the display device. The viewing criteria for each of the display devices 130, 140, and 150 may be determined based on viewing preferences that are input by the viewer and a viewing history of the viewer.

After generating the channel program recommendation, each of the display devices 130, 140, and 150 outputs the channel program recommendation for its viewer. In one embodiment, a notification of the channel program recommendation may be displayed on the display unit of each of the display devices 130, 140, and 150. Alternatively or additionally, the notification may be transmitted to an external device of the viewer such as a mobile phone, a tablet computer, a laptop computer, or a personal computer. In response to the channel program recommendation, the viewer may select a desired channel to be displayed on any of the display devices 130, 140, and 150.

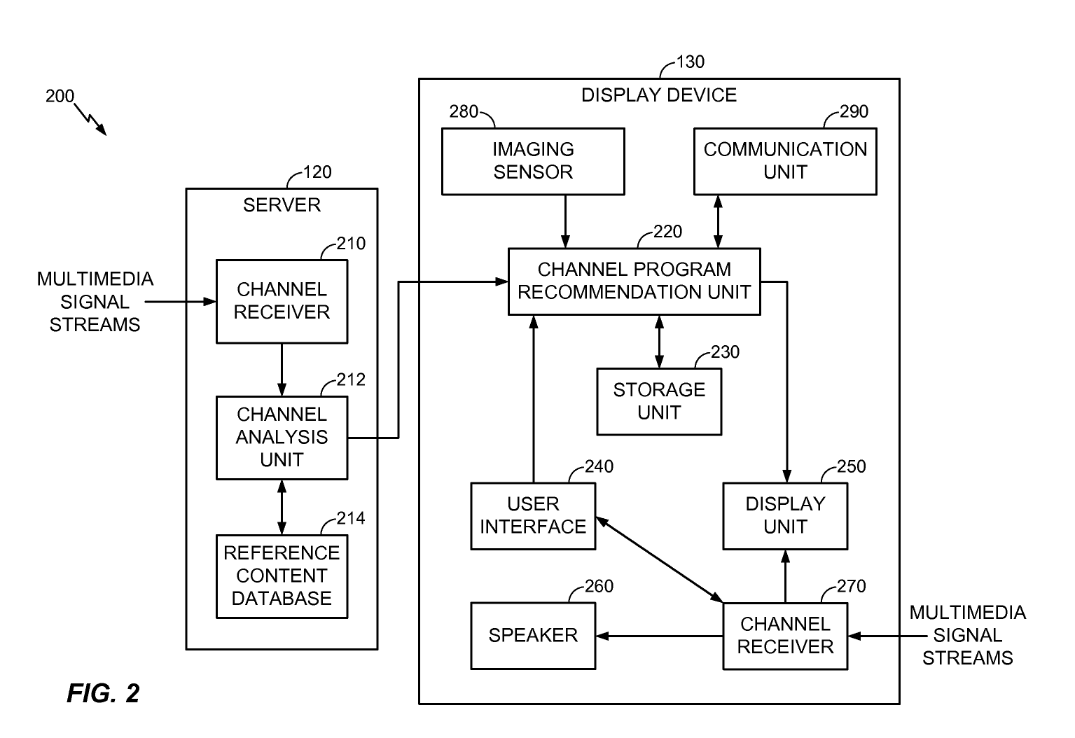

FIG. 2 illustrates a system 200 including the server 120 and the display device 130 for generating a channel program recommendation in real-time according to one embodiment of the present disclosure. The server 120 includes a channel receiver 210, a channel analysis unit 212, and a reference content database 214 for generating video and audio content tags for a plurality of channel programs. The display device 130 includes a channel program recommendation unit 220 configured to generate a channel program recommendation based on the video and audio content tags from the server 120.

The channel receiver 210 in the server 120 is configured to receive the multimedia signal streams and output a plurality of channels including video and audio contents of a plurality of channel programs. The channel analysis unit 212 is configured to receive the channels including the video and audio contents of the channel programs and generate video and audio content tags for the channel programs by analyzing the video and audio contents of the channel programs. A content tag for a channel program indicates the context for the channel program and may be associated with identification information of the channel program such as a channel number, a name of a channel program, a name of a broadcast station, and the like. In some embodiments, a content tag may include any information characterizing video and/or audio contents of a channel program such as a name of an actor or an actress, a name of a singer, a topic of speech, a name of a soundtrack, an exciting event in the channel program, and so forth.

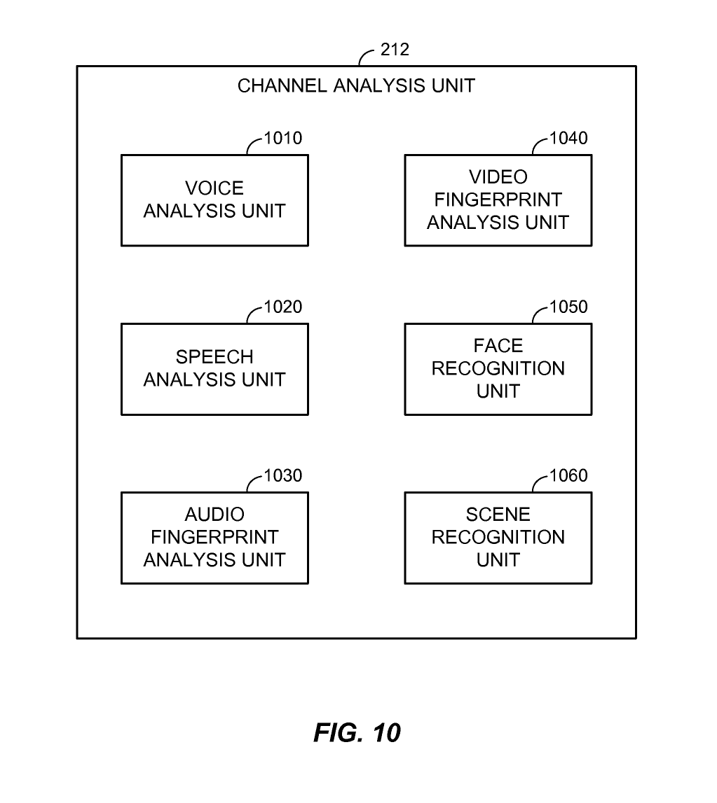

The channel analysis unit 212 is configured to generate the video and audio content tags by analyzing the video and audio contents using any suitable video and/or audio analysis methods such as a voice analysis, a speech analysis, an audio fingerprint analysis, a video fingerprint analysis, a scene analysis, a face recognition analysis, and the like. The reference content database 214 may include a video fingerprint database, an audio fingerprint database, a facial feature database, a voice model database, an object database, a background sound database, an acoustic model database, a facial model database, an object model database, and the like. In some embodiments, the channel analysis unit 212 may access the databases in the reference content database 214 to search for information associated with the video and audio contents. As will be described in more detail below with reference to FIG. 10, each of the databases in the reference content database 214 may be used for determining content information that may be included in a content tag for a channel program.

The channel analysis unit 212 transmits the content tags for the channel programs to the channel program recommendation unit 220 in the display device 130. In one embodiment, the channel analysis unit 212 may analyze the video and audio contents of the channel programs and generate video and audio content tags at a predetermined time interval, e.g., every k seconds. In this case, the content tags may be transmitted to the channel program recommendation unit 220 as they are generated.

The display device 130 further includes a storage unit 230, a user interface 240, a display unit 250, a speaker 260, a channel receiver 270, an imaging sensor 280, and a communication unit 290. The storage unit 230 is configured to store viewing criteria including a viewing history and viewing preferences of a viewer. The storage unit 230 may include any suitable type of a memory device including a RAM (Random Access Memory), a ROM (Read Only Memory), an EEPROM (Electrically Erasable Programmable Read Only Memory), or a flash memory to store various types of information and data.

The viewing history may include channel programs that have been viewed by the viewer, and associated context for the channel programs. The viewer may input viewing preferences through an input device (e.g., a remote control, a keyboard, etc.) and the viewing preferences may include specific contents such as a topic for a news or talk show program, an actor or actress, a singer, music, a movie, a sporting event, an exciting event, and so forth. The user interface 240 is configured to receive and provide the viewer's viewing preferences to the channel program recommendation unit 220 for use in generating the channel program recommendation.

The channel receiver 270 receives the multimedia signal streams including the video and audio contents of the channel programs from the content provider 110. The viewer may select one or more channels from the channel receiver 270 for output on the display unit 250 and the speaker 260. For the selected channel, the display unit 250 is configured to display the video contents of the channel program received from the channel receiver 270, while the speaker 260 is configured to output the audio contents of the channel program for the selected channel.

The imaging sensor 280 is configured to capture an image in the field of view of the display device 130 to identify the viewer. The image is then provided to the channel program recommendation unit 220, which may be configured to identify the viewer by a facial recognition analysis if the image includes the viewer's face. For the facial recognition analysis, reference facial features of the viewer may be captured through the imaging sensor 280 and stored in the storage unit 230 during an initial setup process to identify the viewer.

If the viewer has been recognized by the facial recognition analysis, the channel program recommendation unit 220 may associate the viewer with the viewing criteria including the viewing history and the viewer's viewing preferences for generating a channel program recommendation. On the other hand, if the viewer is not recognized, the channel program recommendation unit 220 may send a notification of a channel program recommendation to an external device associated with the viewer through the communication unit 290. It should be appreciated that the channel program recommendation unit 220 may generate a channel program recommendation for any number of viewers by storing reference facial features and viewing criteria for each of the viewers.

The channel program recommendation unit 220 is configured to receive the content tags for the channel programs from the channel analysis unit 212 in the server 120. The channel program recommendation unit 220 also accesses a set of viewing criteria from the storage unit 230 for a viewer who may be identified via the imaging sensor 280. Further, the viewing criteria may be updated by receiving viewing preferences from the viewer through the user interface 240.

Based on the content tags and the viewing criteria, the channel program recommendation unit 220 generates a channel program recommendation, which may be provided to the display unit 250 for display. In one embodiment, the channel program recommendation unit 220 may generate and output a notification of the channel program recommendation on the display unit 250 and/or the speaker 260. For example, the channel program recommendation may be displayed on the display unit 250 using any suitable display format such as a picture-in-picture (PIP) window, a divided screen, a text message, etc. The notification may also be in the form of a sound indicating the channel program recommendation that may be output through the speaker 260. If it is determined that the viewer is not in the field of view of the imaging sensor 280, the notification may be transmitted via the communication unit 290 to an external device of the viewer, on which the notification may be displayed or output.

As illustrated herein, the display device 130 may be any suitable device such as a television, a smart TV, a cellular phone, a smartphone, a laptop computer, a tablet computer, or a personal computer equipped to receive multimedia broadcast signals to output one or more channel programs. In another embodiment, the units 220, 230, 240, 270, 280 and 290 in the display device 130 may be provided in an external device (e.g., a set-top box) and the display device 130 may include the display unit 250 and the speaker 260. In this case, the external device generates a channel program recommendation for display on the display device 130. It should be appreciated that the display devices 140 and 150 of FIG. 1 may also be implemented in a manner similar to the display device 130.

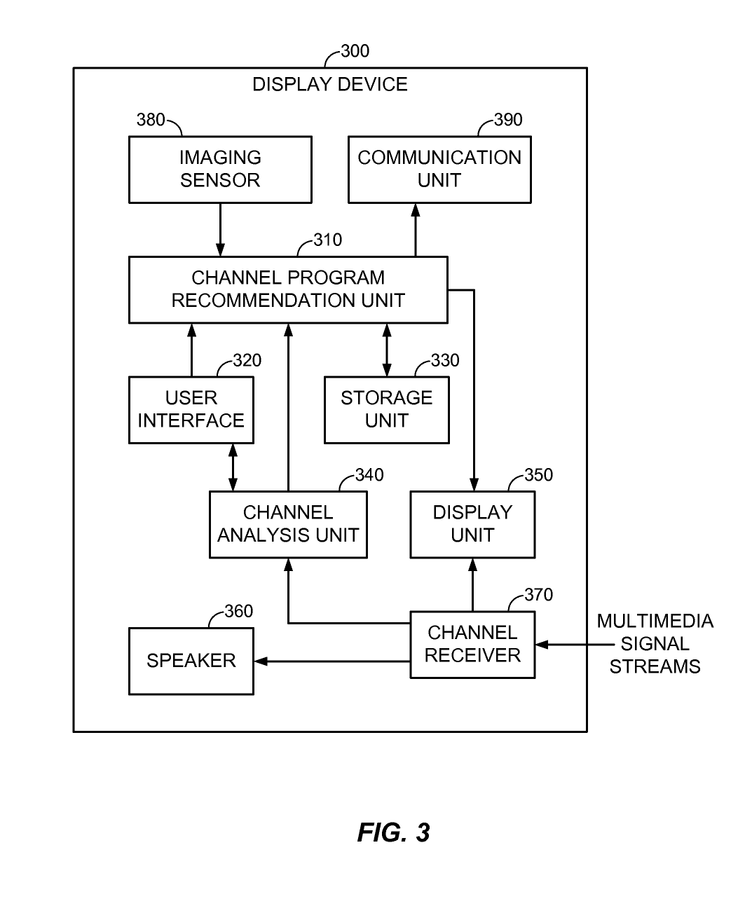

FIG. 3 illustrates a display device 300 configured to generate video and audio content tags for a plurality of channel programs and output a notification of a channel program recommendation according to another embodiment of the present disclosure. The display device 300 includes a channel program recommendation unit 310, a user interface 320, a storage unit 330, a channel analysis unit 340, a display unit 350, a speaker 360, a channel receiver 370, an imaging sensor 380, and a communication unit 390. Differently from the display device 130 of FIG. 2, the display device 300 includes the channel analysis unit 340 configured to generate video and audio content tags of the plurality of channel programs. It should be appreciated that the units 310, 320, 330, 350, 360, 370, 380, and 390 of the display device 300 perform similar functions to the units 220, 240, 230, 250, 260, 270, 280, and 290 of the display device 130, respectively.

In this embodiment, the content provider 110 may transmit multimedia signal streams including video and audio contents of the channel programs to the display device 300. The channel receiver 370 of the display device 300 is configured to receive and transmit the video and audio contents of the channel programs to the channel analysis unit 340. Based on the received video and audio contents, the channel analysis unit 340 may generate video and audio content tags for the channel programs.

Similar to the channel analysis unit 212 of the server 120 in FIG. 2, the channel analysis unit 340 may analyze the video and audio contents using any suitable video and/or audio analysis for generating the content tags. When performing the video and/or audio analysis, the channel analysis unit 340 may access the storage unit 330, which includes a reference content database similar to the reference content database 214 in the server 120. Then, the channel analysis unit 340 transmits the content tags for the channel programs to the channel program recommendation unit 310, which is configured to generate the channel program recommendation for the viewer based on the viewer's viewing preferences and viewing criteria, as described above with reference to FIG. 2.

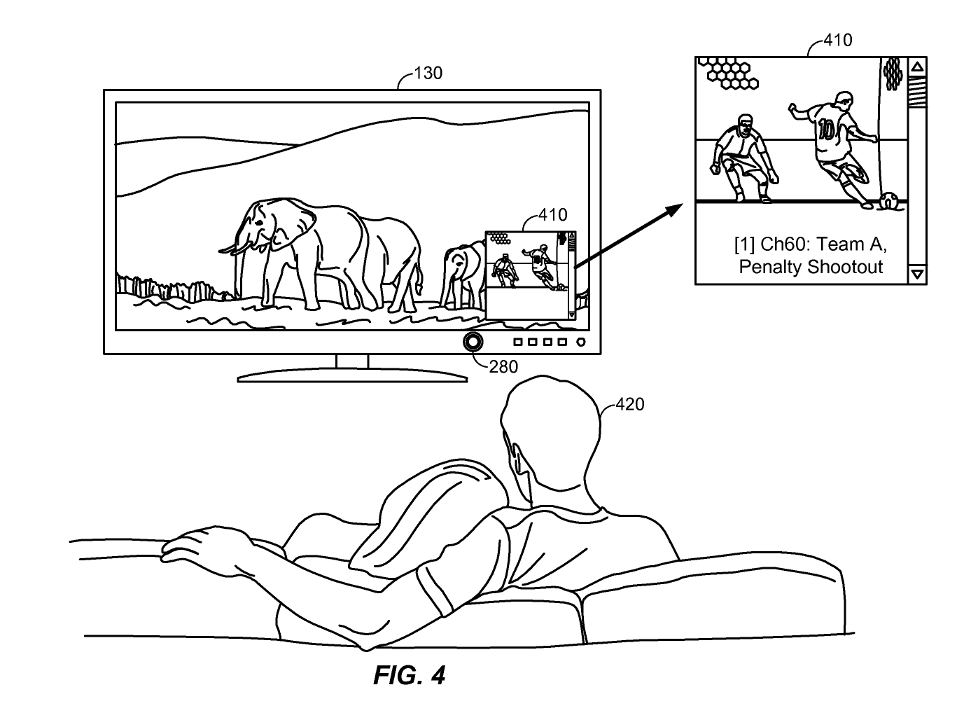

FIG. 4 illustrates a recommendation window 410 displaying an exemplary channel program recommendation of an exciting event on the display device 130 according to one embodiment of the present disclosure. The display device 130 generates the channel program recommendation based on viewing criteria of a viewer 420 indicating that the viewer 420 is interested in watching an exciting event such as a penalty shootout in a soccer game. The recommendation window 410 may also display other channel programs that are prioritized according to the viewing criteria. The viewer may view such channel programs by using a scroll bar on the recommendation window 410.

For generating an exciting event as a channel program recommendation, a scene analysis may be performed on video and audio contents of a plurality of channel programs for a plurality of channels. The channel analysis unit 212 performs such an analysis on the video and audio contents of the channel programs to generate video and audio content tags of the channel programs. In one embodiment, the channel analysis unit 212 may determine that a soccer game has ended in a draw and is about to have a penalty shootout on Channel 60. For example, the channel analysis unit 212 may perform a scene analysis on the video contents of Channel 60 to recognize the soccer game by analyzing faces of players, a game field configuration, a goal post, a game ball, a game score, etc. Further, the audio contents of Channel 60 may be analyzed to recognize speech of commentators, background sounds such as crowd noise, music, etc. Based on the scene analysis, the channel analysis unit 212 may generate a content tag for Channel 60 including the recognized context and/or information on the contents of the channel program such as names of the players, a penalty shootout context, teams, scores, etc.

The channel program recommendation unit 220 of the display device 130 may receive the content tags for the channels including Channel 60 from the channel analysis unit 212 of the server 120. Based on the received content tags of the channels and the viewing criteria, the channel program recommendation unit 220 generates the channel program recommendation including a plurality of channel programs ordered according to a priority based on the viewing criteria. The program recommendation is then displayed on the display device 130.

In the illustrated embodiment, while the viewer 420 is watching a documentary program on a channel, the channel program recommendation is displayed on the recommendation window 410 in a picture-in-picture format. The displayed program recommendation notifies the viewer 420 of the penalty shootout on Channel 60 as a top recommendation for the viewer. The top recommendation is indicated on the bottom of the recommendation window 410 as “[1]” along with a brief description of Channel 60. In response, the viewer 420 may continue to watch the displayed documentary program or select Channel 60 to view the penalty shootout on the full screen of the display device 130.

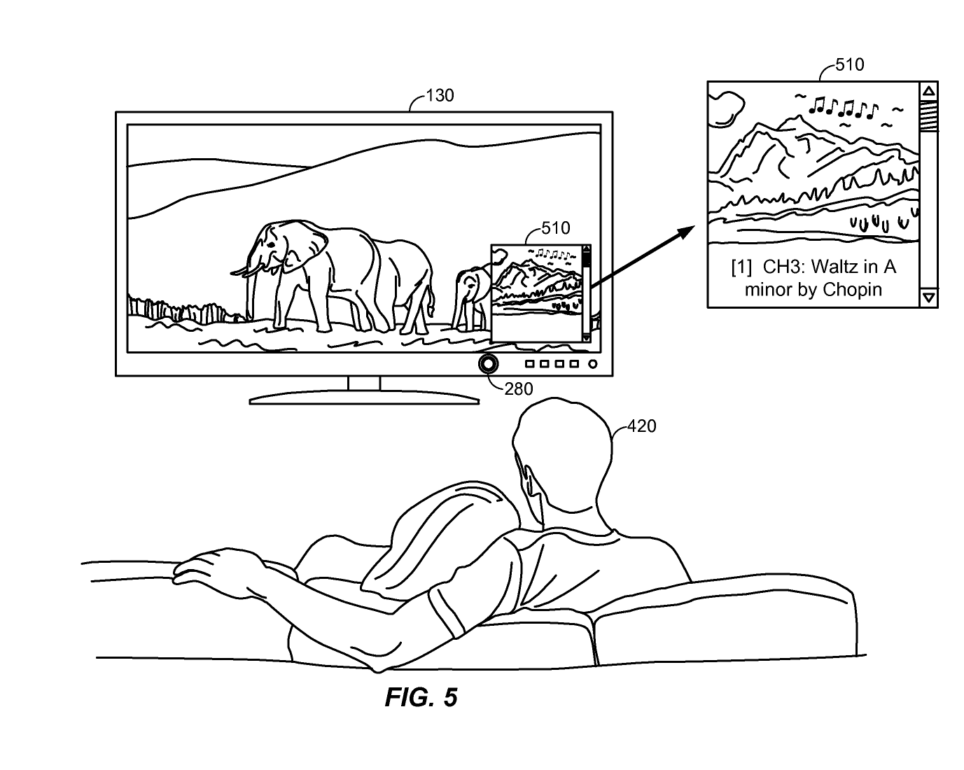

FIG. 5 illustrates a recommendation window 510 displaying an exemplary channel program recommendation of a channel program which includes a particular piece of music on the display device 130 according to one embodiment of the present disclosure. In this embodiment, the display device 130 generates the channel program recommendation based on viewing criteria from the viewer 420 indicating that the viewer 420 is interested in watching a channel program playing classical music. Similar to FIG. 4, the recommendation window 510 may also display other channel programs that are prioritized according to the viewing criteria, and the viewer may view such channel programs by using a scroll bar on the recommendation window 510.

For generating in real-time a channel program recommendation including a channel program playing classical music, an audio fingerprint analysis may be performed on the audio contents of the channel programs. In one embodiment, the audio fingerprint is generated for the audio contents for a channel program and then compared with a plurality of reference audio fingerprints stored in the reference content database 214 of the server 120. If it is determined that the reference content database 214 includes a matching reference audio fingerprint, content information associated with the reference audio fingerprint (e.g., a title, a playing time, a composer of the music, etc.) may be included in a content tag for the channel program. The channel analysis unit 212 may perform the audio fingerprint analysis for the channel programs and generate a content tag for each channel program. The generated content tags then are transmitted to the channel program recommendation unit 220 for generating the channel program recommendation to be displayed in the recommendation window 510.

In the illustrated embodiment, a content tag for Channel 3 indicates that Waltz in A minor by Chopin is being played as background music on Channel 3. Based on the content tags and the viewing criteria of the viewer 420, the channel program recommendation unit 220 generates a channel program recommendation. In this case, while the viewer 420 is watching a documentary program on a channel, the channel program recommendation, which indicates Channel 3 as a top recommendation for the viewer, is displayed on the recommendation window 510 in a picture-in-picture format. The recommendation window 510 displays “[1]” indicating Channel 3 as the top recommendation along with a brief description (e.g., Waltz in A minor by Chopin) of Channel 3.

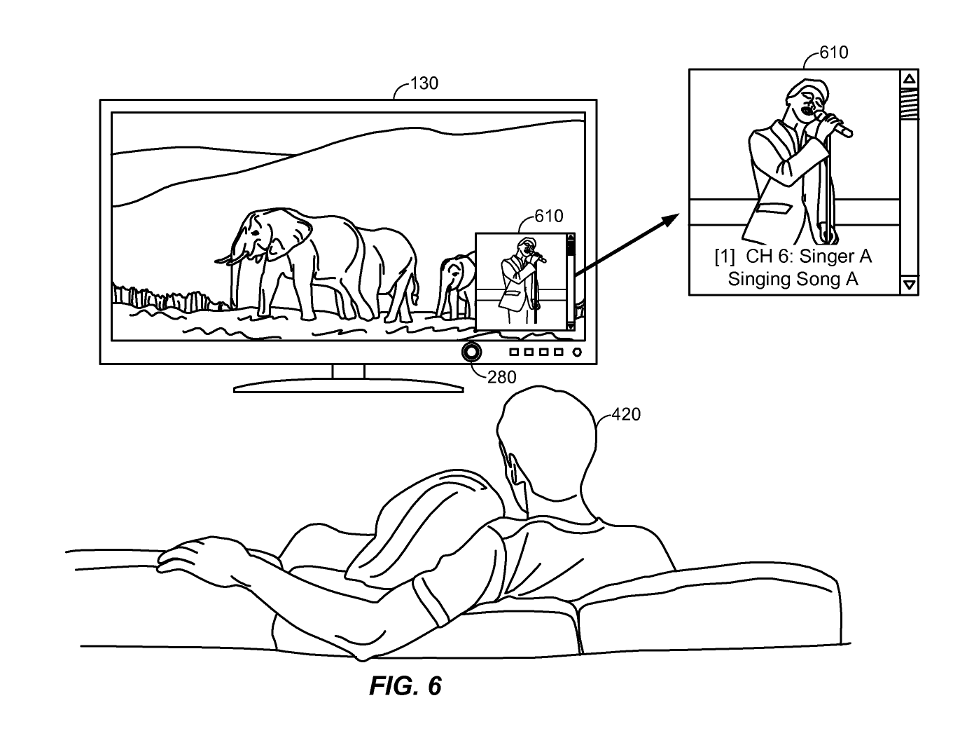

FIG. 6 illustrates a recommendation window 610 displaying an exemplary channel program recommendation of a channel program which includes a singer singing a song on the display device 130 according to one embodiment of the present disclosure. In this embodiment, the viewing criteria of the viewer 420 indicates that the viewer 420 is interested in watching a channel program with Singer A singing Song A. Similar to FIG. 4, the viewer may view other channel programs prioritized according to the viewing criteria by using a scroll bar on the recommendation window 610.

For identifying Singer A, the channel analysis unit 212 may perform a voice analysis on the audio contents of the channel programs by accessing the reference content database 214. In one embodiment, the reference content database 214 may include a plurality of voice models which includes voice samples for a plurality of speakers including Singer A. For the voice analysis, voice characteristics of Singer A may be extracted from Song A and then used to identify Singer A based on the voice models. Based on the voice analysis, the channel analysis unit 212 of the server 120 may generate a content tag for Channel 6 including the name of Singer A.

In another embodiment, a face recognition may be performed to recognize Singer A. The face recognition may identify Singer A by extracting facial features of Singer A from the video contents, and compare the extracted facial features with reference facial features for a plurality of people stored in the reference content database 214. If the channel analysis unit 212 determines that the reference facial features for Singer A are most similar to the extracted facial features, it generates a content tag for Channel 6 including the name of Singer A.

Further, a speech analysis may be performed to identify Song A by recognizing lyrics in Song A. Based on the speech analysis, the channel analysis unit 212 may recognize the words and phrases in Song A and compare the recognized words and phrases with a plurality of lyrics for songs stored in the reference content database 214. Once lyrics for Song A are identified, the channel analysis unit 212 may access the reference content database 214 to determine content information for Song A such as the title for Song A, and generates a content tag for Channel 6 including the title for Song A.

In the illustrated embodiment, the content tag for Channel 6 includes Singer A singing Song A. The channel analysis unit 212 transmits the content tag for Channel 6 to the channel program recommendation unit 220 of the display device 130. The channel program recommendation unit 220 uses content tags of the channels from the channel analysis unit 212 and the viewing criteria from the storage unit 230 to generate the program recommendation, which is then displayed on the display device 130. In FIG. 6, while the viewer 420 is watching a documentary program on a channel, the channel program recommendation is displayed on the recommendation window 610 in a picture-in-picture format. The displayed program recommendation notifies the viewer 420 of Singer A singing Song A on Channel 6 as a top recommendation for the viewer. The top recommendation is indicated on the bottom of the recommendation window 610 as “[1]” along with a brief description of Channel 6.

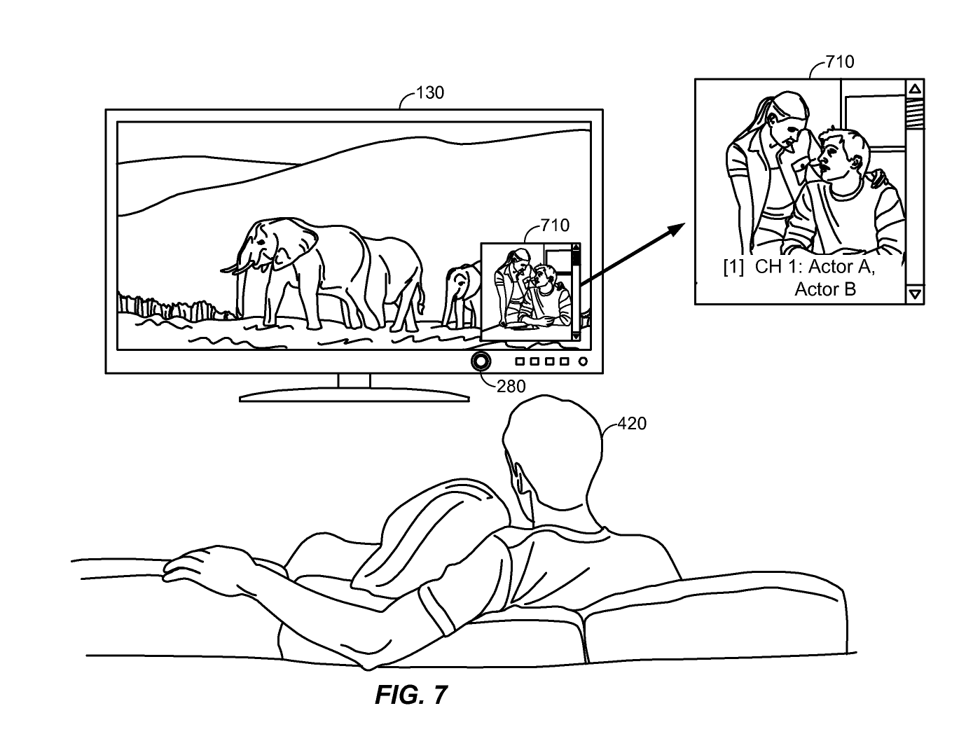

FIG. 7 illustrates a recommendation window 710 displaying an exemplary channel program recommendation of a channel program including actors on the display device 130 according to one embodiment of the present disclosure. Based on viewing criteria from the viewer 420, the channel program recommendation unit 220 generates the channel program recommendation indicating that the viewer 420 is interested in watching a channel program including Actor A and Actor B. Similar to FIG. 4, the viewer may view other channel programs prioritized according to the viewing criteria by using a scroll bar on the recommendation window 710.

In the illustrated embodiment, a face recognition may be performed on the video contents of the channel programs to identify Actor A and Actor B for Channel 1. The face recognition extracts facial features of Actors A and B in the video contents and compares the extracted facial features and reference facial features of faces stored in the reference content database 214. For example, if the channel analysis unit 212 determines that the reference facial features for Actor A are most similar to the extracted facial features, it generates a content tag for Channel 1 including the name of Actor A. In this embodiment, the channel analysis unit 212 may generate a content tag for Channel 1 including the names of Actors A and B based on the face recognition analysis.

Then, the channel analysis unit 212 transmits the content tag for Channel 1 to the channel program recommendation unit 220 of the display device 130. The channel program recommendation unit 220 uses content tags of the channels and the viewing criteria to generate the program recommendation, which is then displayed on the display device 130. In FIG. 7, while the viewer 420 is watching a documentary program on a channel, the program recommendation is displayed on the recommendation window 710 in a picture-in-picture format. The displayed program recommendation notifies the viewer 420 that Actors A and B are recognized for Channel 1 as a top recommendation for the viewer. The recommendation window 710 displays “[1]” indicating Channel 1 as the top recommendation along with a brief description of Channel 1.

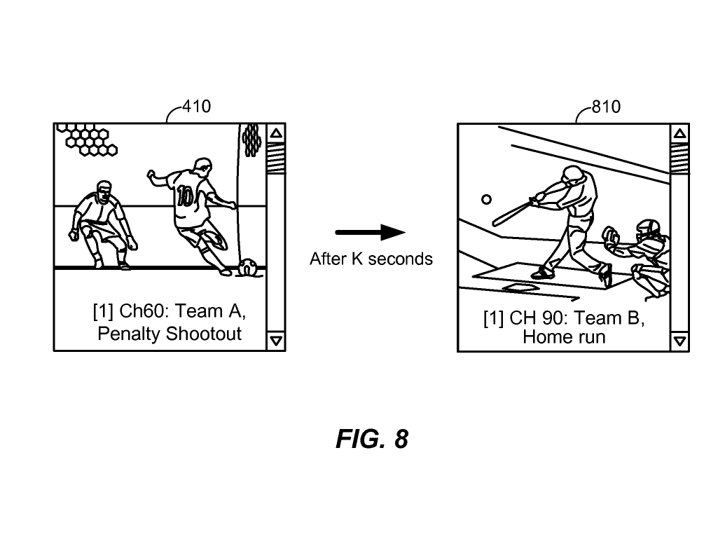

FIG. 8 illustrates updating a picture-in-picture window, which displays a channel program recommendation, with a new channel program recommendation in real-time after a predetermined period of time according to one embodiment of the present disclosure. In this embodiment, the channel analysis unit 212 of the server 120 may generate video and audio content tags for channel programs at a predetermined time interval (e.g., every k seconds). In this case, the content tags are transmitted to the channel program recommendation unit 220 of the display device 130 as they are generated (e.g., every k seconds). Upon receiving the content tags, the channel program recommendation unit 220 generates a new channel program recommendation based on the received content tags and a set of viewing criteria. The new channel program recommendation is provided to the display unit 250 for display in real-time. It should be appreciate that the term “in real-time” may refer to substantially in real-time.

As shown in FIG. 8, the recommendation window 410 provides the channel program recommendation that indicates a penalty shootout in a soccer game involving Team A on Channel 60. The channel program recommendation may have been generated based on the viewing criteria of the viewer 420 indicating that the viewer 420 is interested in watching an exciting event such as a penalty shootout in a soccer game, a homerun in a baseball game, etc. After K seconds, the penalty shootout may be over and another exciting event such as a homerun in a baseball game may be broadcast on Channel 90. In this case, the channel program recommendation unit 220 may generate and display a new channel program recommendation including Channel 90 on a recommendation window 810. In this embodiment, Channel 90 is illustrated as a top recommendation for the viewer. For example, the recommendation window 810 displays “[1]” indicating Channel 90 as the top recommendation along with a brief description of Channel 90. By using a scroll bar on the recommendation windows 410 and 810, the viewer may view other channel programs included in the channel program recommendations of the recommendation windows 410 and 810.

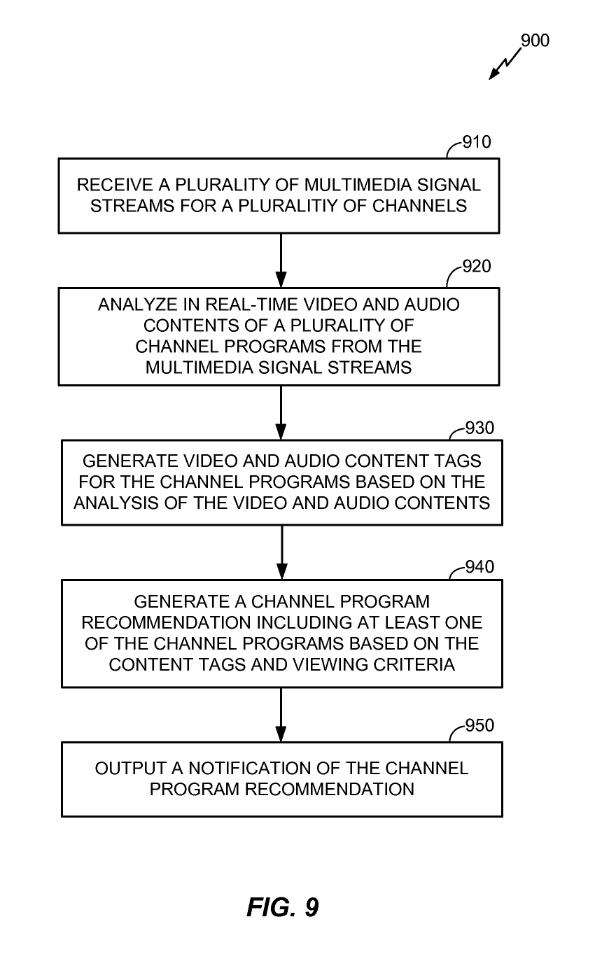

FIG. 9 is a flow chart illustrating a method 900 of providing a notification of a channel program recommendation in real-time for the display device 130 according to one embodiment of the present disclosure. Initially, the server 120 receives multimedia signal streams including video and audio contents of channel programs for a plurality of channels from the content provider 110, at 910. The content provider 110 may also transmit the multimedia signal streams to at least one display device.

At 920, the server 120 then analyzes the video and audio contents of the channel programs in real-time. Based on the analysis of the video and audio contents, the server 120 generates video and audio content tags for the channel programs, at 930. The video and audio content tags are then transmitted to the display device 130. In another embodiment, the video and audio content tags may be generated within the display device 130 without a need of a server.

The display device 130 also accesses the storage unit 230 to receive viewing criteria of a viewer. The viewing criteria may be determined based on a viewing history and viewing preferences of the viewer. Based on the video and audio content tags and the viewing criteria of the viewer, the display device 130 generates the channel program recommendation including at least one channel program, at 940. In addition, a notification of the channel program recommendation may also be generated for output. At 950, the notification is then output to the display unit 250 of the display device 130. Alternatively, the notification of the channel program recommendation may be transmitted to an external device of the viewer.

FIG. 10 illustrates a block diagram of the channel analysis unit 212 configured to receive and analyze video and audio contents of the channel programs in the multimedia signal streams to generate video and audio content tags according to one embodiment of the present disclosure. The channel analysis unit 212 includes a voice analysis unit 1010, a speech analysis unit 1020, an audio fingerprint analysis unit 1030, a video fingerprint analysis unit 1040, a face recognition unit 1050, and a scene recognition unit 1060. For generating the video and audio content tags of the channel programs, the channel analysis unit 212 may use any of the units 1010 to 1060 or any combination thereof to analyze the video and audio contents based on the reference content database 214.

The voice analysis unit 1010 is configured to receive and analyze audio contents of the channel programs and identify a speaker such as an actor, an actress, a singer, etc. based on voice characteristics of the speaker. The reference content database 214 includes voice models of a plurality of speakers, which are generated using a plurality of reference voice features extracted from known voice samples of the speakers to enable identification of the speakers. For each of the channel programs, the voice analysis unit 1010 extracts voice features in the audio contents of the channel programs. The voice analysis unit 1010 also accesses the voice model database in the reference content database 214 and identifies one or more speakers based on the extracted voice features and the voice models of the known speakers. The voice models in the reference content database 214 may be generated using voice processing techniques such as Gaussian mixture models, hidden Markov models, decision trees, neural networks, frequency estimation, etc.

In addition to the voice analysis unit 1010, the channel analysis unit 212 may include the speech analysis unit 1020 to recognize speech in the audio contents. Upon receiving audio contents of the channel programs, the speech analysis unit 1020 performs speech recognition on the audio contents to recognize key words or phrases. In one embodiment, the spoken words in the audio contents may be recognized based on speech features extracted from the audio contents and acoustic models stored in the reference content database 214. For each of the channel programs, the speech analysis unit 1020 extracts speech features in the audio contents of the channel programs. The speech analysis unit 1020 accesses the acoustic model database in the reference content database 214 and identifies key words or phrases based on the extracted speech features and the acoustic models. The acoustic models in the reference content database 214 may be generated using speech processing techniques such as Gaussian mixture models, hidden Markov models, decision trees, neural networks, frequency estimation, etc.

A reference speech database in the reference content database 214 includes a plurality of reference key words and speech content information (e.g., a title, a related topic, a quote, etc.) associated with the reference key words. The text or data of the recognized words may be compared to reference key words in the reference speech database. For example, one or more reference key words (e.g., “husband,” “wife,” “family,” etc.) may indicate speech content information such as topic (e.g., “relationship”). Based on the recognized text or data of the spoken words, the speech analysis unit 1020 may access the reference speech database and identify key words corresponding to the recognized text or data. The speech content information associated with one or more identified key words may then be provided in a content tag.

The audio fingerprint analysis unit 1030 is configured to receive and analyze audio contents of the channel programs to generate audio fingerprints from the audio contents. The audio fingerprint analysis unit 1030 accesses a reference audio fingerprint database in the reference content database 214 using the audio fingerprints to identify reference audio fingerprints. Audio content information for the channel programs may be then determined based on the identified reference audio fingerprints.

The reference audio fingerprint database includes a plurality of reference audio fingerprints for a plurality of audio contents (e.g., a song, background music, etc.) and audio content information associated with the reference audio fingerprints (e.g., a title, a playing time, lyrics, etc.). The content provider 110 may generate and provide the reference audio fingerprints and the associated audio content information to the server 120 to be stored in the reference content database 214 as the reference audio fingerprint database. Alternatively, the audio fingerprint analysis unit 1030 may extract audio characteristics of various audio contents to generate audio fingerprints and associated audio content information. The audio fingerprints and the associated audio content information may be stored in the reference content database 214 as the reference audio fingerprint database.

For each of the audio fingerprints of the received audio contents, the audio fingerprint analysis unit 1030 is configured to identify a reference audio fingerprint in the reference audio fingerprint database. In identifying the reference audio fingerprint, the reference audio fingerprint that has a highest similarity to the audio fingerprint is selected. If the reference fingerprint is identified, the audio content information associated with the identified reference audio fingerprint is output to be included in a content tag.

The video fingerprint analysis unit 1040 is configured to receive and analyze video contents of the channel programs to generate video fingerprints from the video contents. The video fingerprint analysis unit 1040 then determines video content information for channel programs using the video fingerprints by accessing a reference video fingerprint database in the reference content database 214. The reference video fingerprint database includes a plurality of reference video fingerprints for a plurality of video contents and video content information associated with the reference video fingerprints (e.g., a title, a playing time, names actors and actress recognized in a particular scene, a summary, etc.).

Similar to the audio fingerprint analysis, the content provider 110 may generate and provide the reference video fingerprints and the associated video content information to the server 120 to be stored in the reference content database 214 as the reference video fingerprint database. Alternatively, the video fingerprint analysis unit 1040 may extract visual characteristics of various video contents to generate video fingerprints and associated video content information. The video fingerprints and the associated video content information may be stored in the reference content database 214 as the reference video fingerprint database.

Upon receiving the video contents for the channel programs, the video fingerprint analysis unit 1040 generates video fingerprints by extracting visual characteristics (e.g., color, motion changes, etc.) from the video contents of the channel programs. The video fingerprint analysis unit 1040 is configured to identify a reference video fingerprint, which has a highest similarity to the video fingerprint, in the reference video fingerprint database. Once identified, the video content information associated with the identified reference video fingerprint may be included in a content tag.

The face recognition unit 1050 is configured to receive and analyze the video contents of the channel programs, and performs facial recognition by accessing a facial feature database in the reference content database 214. In one embodiment, the face recognition unit 1050 may recognize a person (e.g., an actor, an actress, a singer, etc.) by detecting a face in the video contents and extracting facial features of the detected face. The facial feature database includes reference facial features of a plurality of people and identities (e.g., names) of the persons associated with the facial features. The extracted facial features of the person are used to access the reference facial feature database and identify the reference facial features that best match the extracted facial features. The identity of a reference person associated with the identified reference facial features may be included in a content tag.

In one embodiment, identities of the persons in the video contents may be recognized based on facial features extracted from the video contents and facial models of a plurality of people stored in the reference content database 214. For each of the channel programs, the face recognition unit 1050 extracts facial features in the video contents of the channel programs. The face recognition unit 1050 accesses the facial model database in the reference content database 214 and identifies the persons based on the extracted facial features and the facial models. The facial models in the reference content database 214 may be generated using any suitable image processing techniques.

The scene recognition unit 1060 is configured to receive video and audio contents and recognize an event in the video and audio contents by performing a scene analysis. The scene analysis may include a speech analysis, a sound analysis, a face recognition, and an object recognition, or a combination thereof. In one embodiment, the scene recognition unit 1060 may perform the scene analysis by using or coordinating with the voice analysis unit 1010, the speech analysis unit 1020, the audio fingerprint analysis unit 1030, the video fingerprint analysis unit 1040, and the face recognition unit 1050, or any combination thereof. Alternatively, one or more of these units 1010 to 1050 may be provided directly in the scene recognition unit 1060 for use in the scene analysis. As used herein, the term “event” refers to any occurrence having a specified context such as a location, time, etc., and may include events such as a sporting event, a live-cast event (e.g., a concert, a musical, an on-the-scene news report, etc.), or the like.

In recognizing an event in the video and audio contents, the scene recognition unit 1060 may determine whether the video and audio contents include some specific objects, features, and/or activities. The scene recognition unit 1060 is configured to recognize objects in the video contents by accessing a reference object database in the reference content database 214. The reference object database includes a plurality of reference object features for a plurality of objects (e.g., a ball, a stadium, a score board, a net, etc.), and associated information on the objects (e.g., related event, a location, a team, etc.). The scene recognition unit 1060 may identify reference object features that best match the features of the recognized object, and output the information on the object associated with the identified reference object. The object information may then be included in a content tag.

In one embodiment, the objects in the video contents may be recognized based on object features extracted from the video contents and object models of a plurality of objects stored in the reference content database 214. For each of the channel programs, the scene recognition unit 1060 extracts object features in the video contents of the channel programs. The scene recognition unit 1060 accesses the object model database in the reference content database 214 and identifies the object based on the extracted object features and the object models. The object models in the reference content database 214 may be generated using any suitable image processing techniques.

Additionally or alternatively, the scene recognition unit 1060 may be configured to determine background sounds (e.g., crowd noise, environmental noise, animal noise, mechanical noise, etc.). The scene recognition unit 1060 may identify a background sound by extracting sound features from the background sound and comparing the extracted sound features with reference background sound features, which are associated with a plurality of known background sounds in a reference background sound database. A known background sound associated with the best matching reference background sound features is then identified as the background sound. In this manner, a plurality of background sounds may be identified and given different weights in determining whether an event associated with the background sound is an “exciting” event.

In one embodiment, the background sound in the audio contents may be recognized based on background sound features extracted from the audio contents and acoustic models stored in the reference content database 214. For each of the channel programs, the scene recognition unit 1060 extracts speech features in the audio contents of the channel programs. The scene recognition unit 1060 accesses the acoustic model database in the reference content database 214 and identifies the background sound based on the extracted background sound features and the acoustic models. The acoustic models in the reference content database 214 may be generated using sound processing techniques such as Gaussian mixture models, hidden Markov models, decision trees, neural networks, frequency estimation, etc.

For example, crowd noise may indicate an exciting event according to the intensity of the noise. In this case, if the noise is louder, the scene recognition unit 1060 may determine that the associated event is an exciting event. The event associated with the noise may also be determined through the scene analysis including at least one of the voice analysis, the speech analysis, the audio fingerprint analysis, the video fingerprint analysis, and the face recognition, or any combination thereof. Based on the above analysis, the scene recognition unit 1060 may recognize that the video and audio contents include an exciting event, and provide an indication of the exciting event to be included in a content tag.

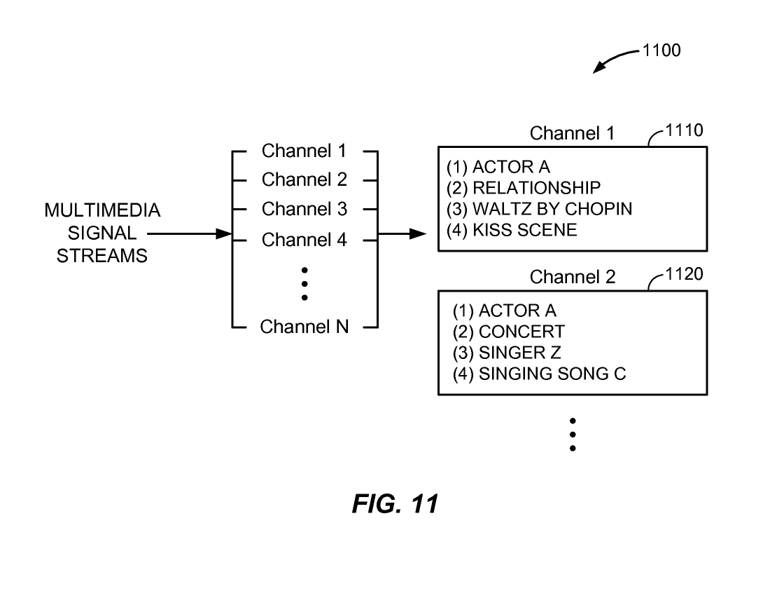

FIG. 11 illustrates generating, in the channel analysis unit 212, video and audio content tags for a plurality of channels according to one embodiment of the present disclosure. The server 120 receives multimedia signal streams from the content provider 110 including video and audio contents for channel programs of the plurality of channels. The video and audio contents for each of the channels are then analyzed to generate a video and audio content tag for each channel.

The channel analysis unit 212 performs a voice analysis, an audio fingerprint analysis, speech analysis, a scene recognition, an audio fingerprint analysis, and/or a face recognition, as described above with reference to FIG. 10. The video and audio content tags may include a plurality of specific content categories. In the illustrated embodiment, four categories for the content tags (i.e., actor or actress, topic of speech or a news report, music, an exciting event) are defined.

The channel analysis unit 212 may analyze the video and audio contents for the specific content categories and generate a content tag for each channel that includes the names of actors, the topic of speech, music played, and an event. For example, a content tag 1110 for Channel 1 includes Actor A, a speech associated with a relationship, Waltz by Chopin being played, and a kiss scene while a content tag 1120 for Channel 2 includes Actor A, a speech associated with a concert, and Singer Z singing Song C. The generated content tags 1110 and 1120 for the channels are then transmitted to the channel program recommendation unit 220 for generating a channel program recommendation.

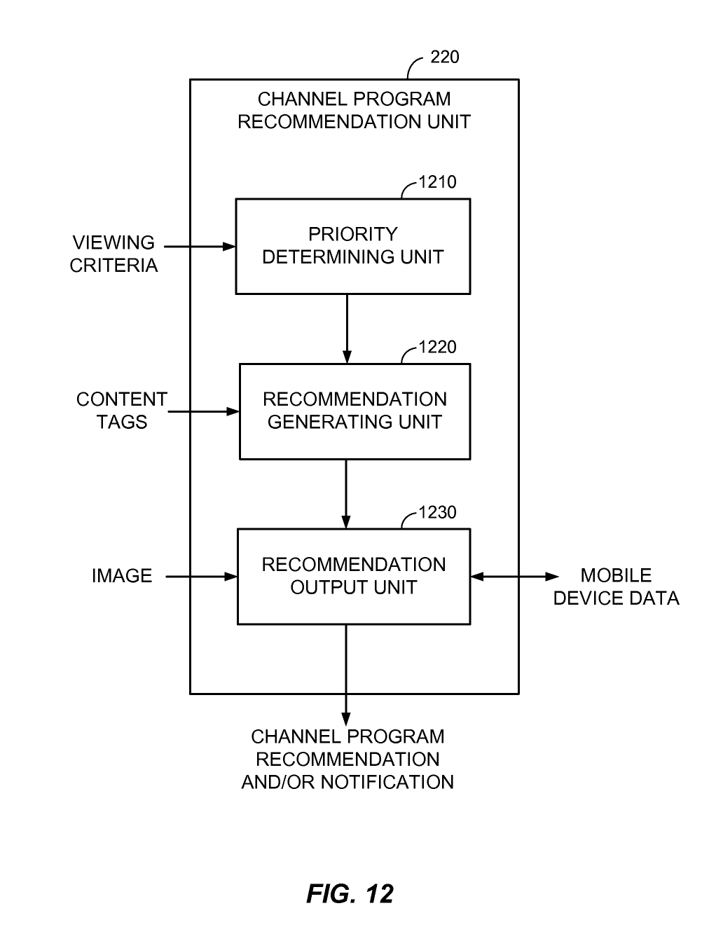

FIG. 12 illustrates a block diagram of the channel program recommendation unit 220 of the display device 130 that is configured to generate a channel program recommendation according to one embodiment of the present disclosure. The channel program recommendation unit 220 includes a priority determining unit 1210, a recommendation generating unit 1220, and a recommendation output unit 1230. The channel program recommendation unit 220 may also be used as the channel program recommendation unit 310 of FIG. 3.

In the illustrated embodiment, the priority determining unit 1210 accesses viewing criteria of a viewer in the storage unit 230 and/or receives viewing preferences via the user interface 240. The priority determining unit 1210 may also be configured to prioritize the viewing criteria of the viewer by assigning a weight to each of the criterion. For example, if the viewing history indicates a frequent viewing of channel programs that include a particular criterion (e.g., an actor or actress), then the criterion may be given more weight in determining a priority among the viewing criteria. Also, a viewing criterion may be given more weight if the viewer has recently selected a channel program including the viewing criterion. The viewing criteria may be determined while the viewer is watching a channel program and can be continuously updated to reflect the viewer's viewing history and viewing preferences.

On the other hand, the priority determining unit 1210 may provide a higher priority for viewing preferences inputted by the viewer than the viewing history. For example, if the viewer inputs a viewing preference for a “baseball game,” the baseball game may be given a high priority even if the viewer has watched mostly soccer games in the past. Based on the weights given to the viewing history and viewing preferences of the viewer, the viewing criteria may be prioritized according to their relative weights. Then, the priority determining unit 1210 transmits the prioritized viewing criteria to the recommendation generating unit 1220. In one embodiment, the weights of the viewing criteria may also be provided to the recommendation generating unit 1220.

The recommendation generating unit 1220 receives video and audio content tags for a plurality of channel programs on a plurality of channels from the server 120 and the prioritized viewing criteria from the priority determining unit 1210. The recommendation generating unit 1220 then compares the prioritized viewing criteria and each of the video and audio content tags, which may include a recognized context and/or information on the contents of the associated channel program such as names of performers (e.g., an actor, an actress, a singer, etc.), a topic of discussion, an event, a sporting game, etc. For each of the video and audio content tags, the recommendation generating unit 1220 determines whether the content tag for a channel program includes one or more viewing criteria. If the recommendation generating unit 1220 determines that the content tag for a channel program does not include a viewing criterion, the channel associated with the channel program may be excluded from the channel program recommendation.

When a content tag for a channel program includes one or more viewing criteria, the channel program is added to a channel program recommendation. In this manner, a plurality of channel programs may be added to the channel program recommendation. The recommendation generating unit 1220 may prioritize the channel programs according to the weights of the associated viewing criteria and outputs the prioritized channels as the channel program recommendation. The channel program recommendation is then transmitted to the recommendation output unit 1230.

The recommendation output unit 1230 may receive an image captured from the imaging sensor 280 in the field of view of the display device 130 and determine if the viewer is in the captured image. The recommendation output unit 1230 may identify the viewer in the captured image by a facial recognition analysis on the image. In this case, if a face in the captured image is identified to be that of the viewer, the channel program recommendation may be output to the display unit 250 for display. On the other hand, if the viewer is not recognized, the recommendation output unit 1230 may generate and output a notification of the channel program recommendation to an external device (e.g., mobile device) of the viewer via the communication unit 290. The external device may then output the notification for the viewer.

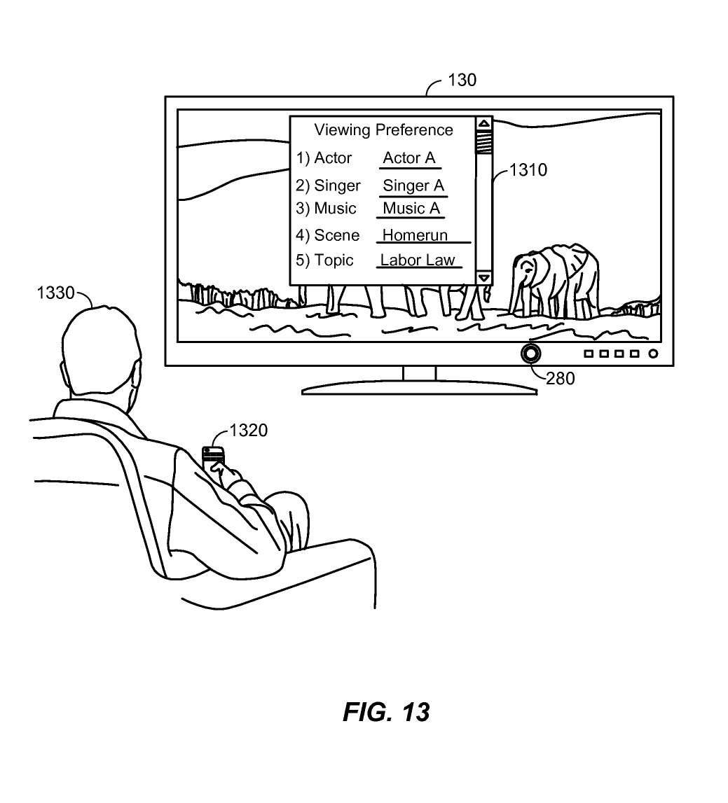

FIG. 13 shows a diagram illustrating a viewer inputting his or her viewing preferences on the display device 130 for use in prioritizing a channel program recommendation according to one embodiment of the present disclosure. The display device 130 is configured to receive viewing preferences for use in generating viewing criteria for the viewer. The viewing preferences of the viewer are input by a viewer 1330 through an input device 1320 (e.g., a remote control, a keyboard, etc.), and may include the viewer's interest and concern such as specific contents (e.g., a topic for a news or talk show program, an actor or an actress, a singer, music, a movie, a sporting event, an exciting event, etc.).

The viewer 1330 may manipulate the input device 1320 for the display device 130 to display a viewing preference window 1310 in a picture-in-picture format on the display device 130. The viewing preference window 1310 indicates viewing preferences for a plurality of contents, and the viewer 1330 may identify his or her viewing preferences by selecting or inputting any one of the contents using the input device 1320. The viewer 1330 may view additional contents for viewer preferences by using a scroll bar on the viewing preference window 1310. In one embodiment, when the viewer 1330 completes inputting his or her viewing preferences on the viewing preference window 1310, the viewing preferences are provided to the channel program recommendation unit 220 for use in generating a channel program recommendation. When prioritizing the viewer's viewing criteria, higher weights may be given to the viewing preferences currently input by the viewer, and the viewing criteria may be prioritized accordingly.

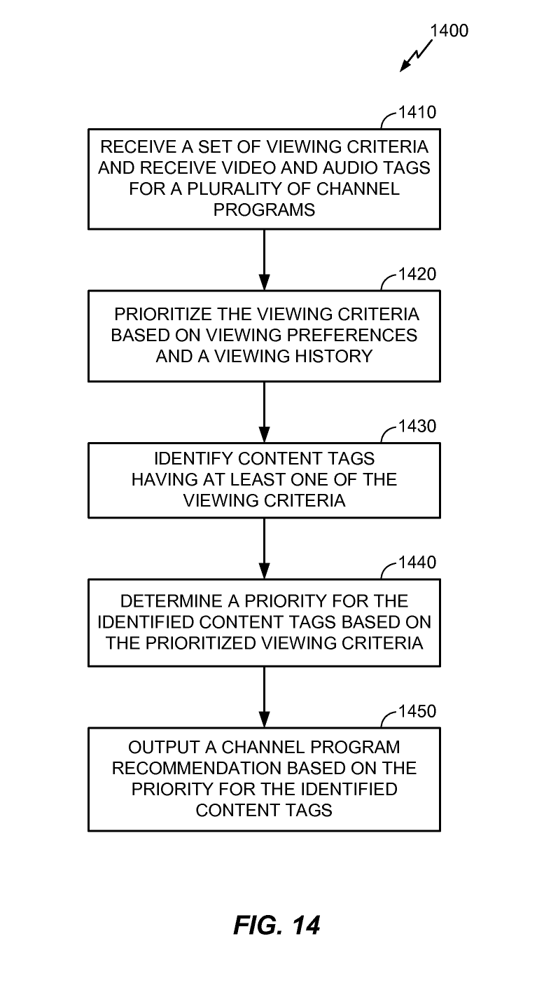

FIG. 14 is a flow chart illustrating a method performed by the channel program recommendation unit 220 for generating a channel program recommendation according to one embodiment of the present disclosure. The server 120 may generate video and audio content tags for a plurality of channel programs by analyzing video and audio contents of the channel programs while the display device 130 generates a set of viewing criteria for a viewer. The video and audio content tags are then transmitted to the channel program recommendation unit 220 of the display device 130.

The channel program recommendation unit 220 receives the content tags from the server 120 and the set of viewing criteria for the viewer from the storage unit 230, at 1410. Then, the viewing criteria are prioritized based on viewing preferences and a viewing history of the viewer, at 1420. The prioritized viewing criteria may then be compared to the content tags for generating the channel program recommendation for the viewer. Specifically, the recommendation generating unit 1220 identifies the content tags including at least one of the viewing criteria, at 1430. Then, a priority for the identified channel programs associated with the identified content tags is determined based on the prioritized viewing criteria, at 1440. The channel program recommendation is generated and output to the display unit 250 based on the priority for the identified channel programs, at 1450.

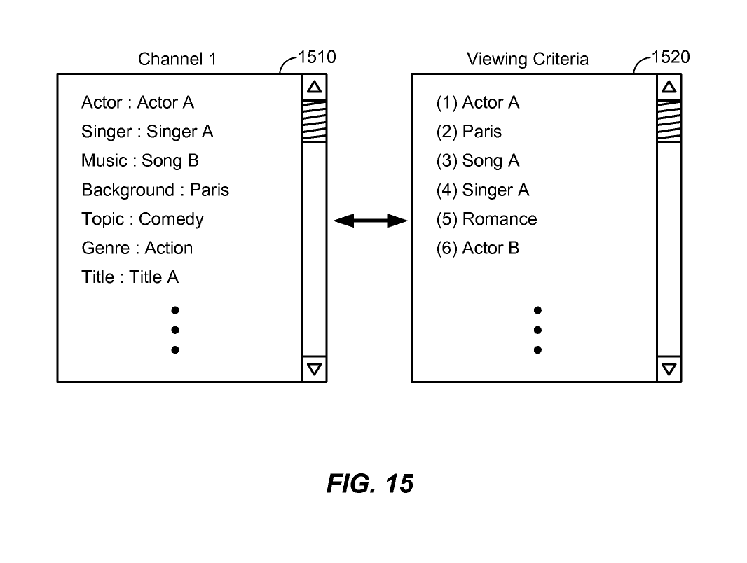

FIG. 15 illustrates comparing a video and audio content tag for a channel program with viewing criteria in the channel program recommendation unit 220 for determining whether to recommend the channel program according to one embodiment of the present disclosure. In this embodiment, a video and audio content tag 1510 for Channel 1 received from the channel analysis unit 212 is compared to a prioritized viewing criteria 1520 generated by the priority determining unit 1210. All content tags for channel programs may be compared to the prioritized viewing criteria 1520 in a similar manner.

The video and audio content tag 1510 for Channel 1 is generated by various analyses illustrated in FIG. 10. The channel analysis unit 212 analyzes video and audio contents of a channel program for Channel 1, and generates the video and audio content tag 1510 to be compared with the prioritized viewing criteria 1520. In this illustrated embodiment, the viewing criteria 1520 are prioritized so that the top of the viewing criteria 1520 indicates what the viewer is most interested in watching. The viewing criteria 1520 are prioritized to indicate that the viewer is most interested in watching a channel program including Actor A, as it is placed on the top of the viewing criteria 1520.

In some embodiments, the channel program recommendation unit 220 may compare the top priority (i.e., Actor A) of the viewing criteria 1520 with the content tag 1510 of Channel 1, and determine that the viewer would be interested in watching Channel 1 since the content tag 1510 for Channel 1 includes the top priority (i.e., Actor A). As such, the channel program recommendation unit 220 may include Channel 1 in a channel program recommendation. In other embodiments, if the top priority of the viewing criteria 1520 does not match content information included in a content tag, the channel program recommendation unit 220 continues to compare the content tags to the viewing criteria 1520 with subsequent priorities for generating the channel program recommendation.

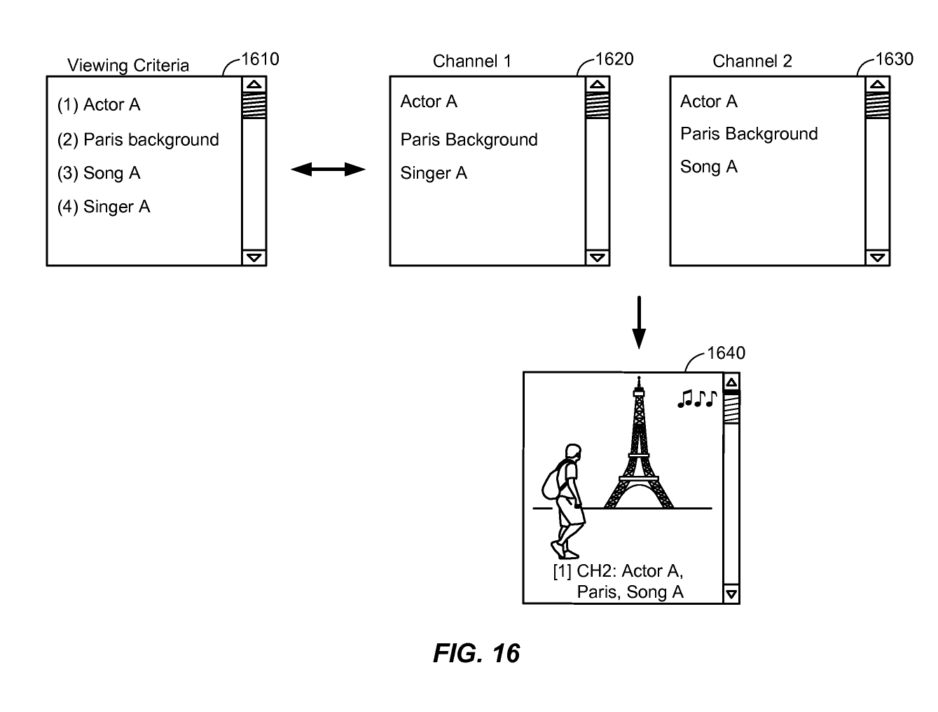

FIG. 16 illustrates comparing video and audio content tags 1620 and 1630 of two channel programs with viewing criteria 1610 and displaying a prioritized channel program recommendation according to one embodiment of the present disclosure. In this embodiment, the channel program recommendation unit 220 prioritized the viewing criteria 1610 based on weights given to the viewing preferences and the viewing history of the viewer. For example, the prioritized viewing criteria 1610 include Actor A as its top priority.

To prioritize the channel program recommendation, the channel program recommendation unit 220 may compare the second priority (i.e., Paris background) of the viewing criteria 1610 with the content tags 1620 and 1630. In this case, both of the content tags 1620 and 1630 also include Paris background, which is the second priority of the viewing criteria 1610. Next, the third priority of the viewing criteria 1610 (e.g., Song A) may be compared to the content tags 1620 and 1630. In the illustrated embodiment, only the content tag 1630 for Channel 2 includes the third priority of the viewing criteria 1610. Accordingly, the channel program recommendation unit 220 generates the channel program recommendation of Channel 2 to be displayed on a channel recommendation window 1640 as a top recommendation for the viewer. The top recommendation is indicated at the bottom of the channel recommendation window 1640 as “[1]” along with a brief description of Channel 2. In this case, the viewer may manipulate the scroll bar on the channel recommendation window 1640 to view the other channel recommendation (i.e., Channel 1).

For generating the prioritized channel program recommendation, the channel program recommendation unit 220 receives the video and audio content tags 1620 and 1630 for Channel 1 and Channel 2 from the server 120. Then, each of the content tags 1620 and 1630 received from the server 120 may be compared to the prioritized viewing criteria 1610. In the illustrated embodiment, the viewing criteria 1610 include Actor A as its top priority, while the content tags 1620 and 1630 also include Actor A. As such, the channel program recommendation unit 220 may determine that Channels 1 and 2 may be included in the channel program recommendation.

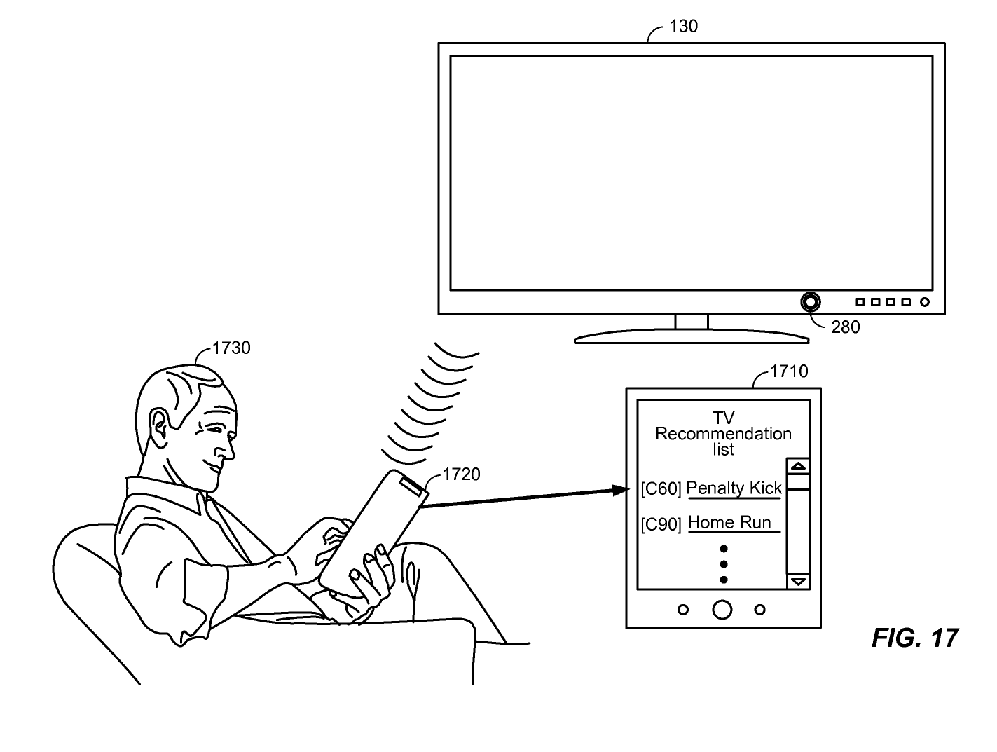

FIG. 17 illustrates a diagram of the display device 130 that transmits a notification 1710 of a channel recommendation to an external device 1720 of a viewer 1730 when the viewer 1730 is not determined to be within a viewable area of the display device 130 according to one embodiment of the present disclosure. The imaging sensor 280 is arranged on the display device 130 to capture an image in the field of view of the display device 130 to identify the viewer. The image is then provided to the channel program recommendation unit 220, which may identify the viewer by a facial recognition analysis on the image including the viewer's face.

As shown in FIG. 17, if the viewer is not recognized, the channel program recommendation unit 220 may identify the external device 1720, which is associated with the viewer 1730. Then, the channel program recommendation unit 220 sends the notification 1710 to the external device 1720. Once the viewer 1730 receives the notification 1710, the viewer 1730 may decide to view one of the channel programs in the notification 1710 on the display device 130. Alternatively, if the viewer is determined to be in a viewable area of the display device 130, the display device 130 may generate a channel program recommendation and display it on the display unit 250 of the display device.

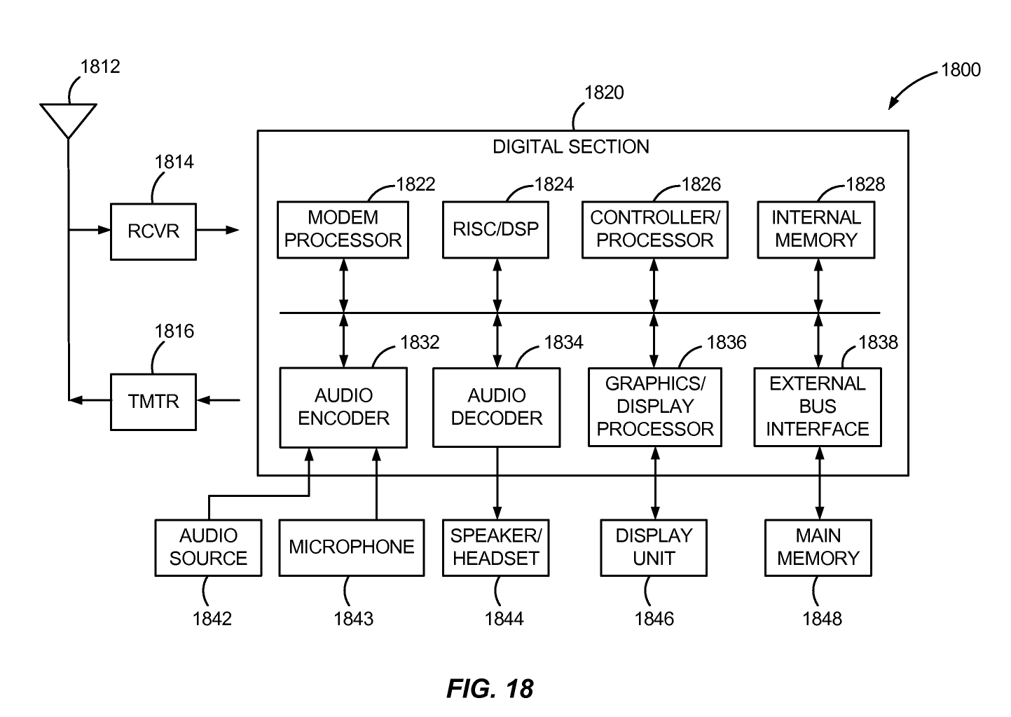

FIG. 18 illustrates a configuration of an exemplary mobile device 1800 in which the method or application of the present disclosure may be executed. The configuration of the mobile device 1800 may be implemented in the mobile devices according to the above embodiments described with reference to FIGS. 1 to 17. The mobile device 1800 may be a cellular phone, a smartphone, a terminal, a handset, a personal digital assistant (PDA), a wireless modem, a cordless phone, etc. The wireless communication system may be a Code Division Multiple Access (CDMA) system, a Broadcast System for Mobile Communications (GSM) system, Wideband CDMA (WCDMA) system, Long Tern Evolution (LTE) system, LTE Advanced system, etc. Further, the mobile device 1800 may communicate directly with another mobile device, e.g., using Wi-Fi Direct, Bluetooth, or FlashLinq technology.

The mobile device 1800 is capable of providing bidirectional communication via a receive path and a transmit path. On the receive path, signals transmitted by base stations are received by an antenna 1812 and are provided to a receiver (RCVR) 1814. The receiver 1814 conditions and digitizes the received signal and provides samples such as the conditioned and digitized digital signal to a digital section for further processing. On the transmit path, a transmitter (TMTR) 1816 receives data to be transmitted from a digital section 1820, processes and conditions the data, and generates a modulated signal, which is transmitted via the antenna 1812 to the base stations. The receiver 1814 and the transmitter 1816 may be part of a transceiver that may support CDMA, GSM, LTE, LTE Advanced, etc.

The digital section 1820 includes various processing, interface, and memory units such as, for example, a modem processor 1822, a reduced instruction set computer/digital signal processor (RISC/DSP) 1824, a controller/processor 1826, an internal memory 1828, a generalized audio encoder 1832, a generalized audio decoder 1834, a graphics/display processor 1836, and an external bus interface (EBI) 1838. The modem processor 1822 may perform processing for data transmission and reception, e.g., encoding, modulation, demodulation, and decoding. The RISC/DSP 1824 may perform general and specialized processing for the mobile device 1800. The controller/processor 1826 may perform the operation of various processing and interface units within the digital section 1820. The internal memory 1828 may store data and/or instructions for various units within the digital section 1820.

The generalized audio encoder 1832 may perform encoding for input signals from an audio source 1842, a microphone 1843, etc. The generalized audio decoder 1834 may perform decoding for coded audio data and may provide output signals to a function determining engine 1844. The graphics/display processor 1836 may perform processing for graphics, videos, images, and texts, which may be presented to a display unit 1846. The EBI 1838 may facilitate transfer of data between the digital section 1820 and a database 1848.

The digital section 1820 may be implemented with one or more processors, DSPs, microprocessors, RISCs, etc. The digital section 1820 may also be fabricated on one or more application specific integrated circuits (ASICs) and/or some other type of integrated circuits (ICs).

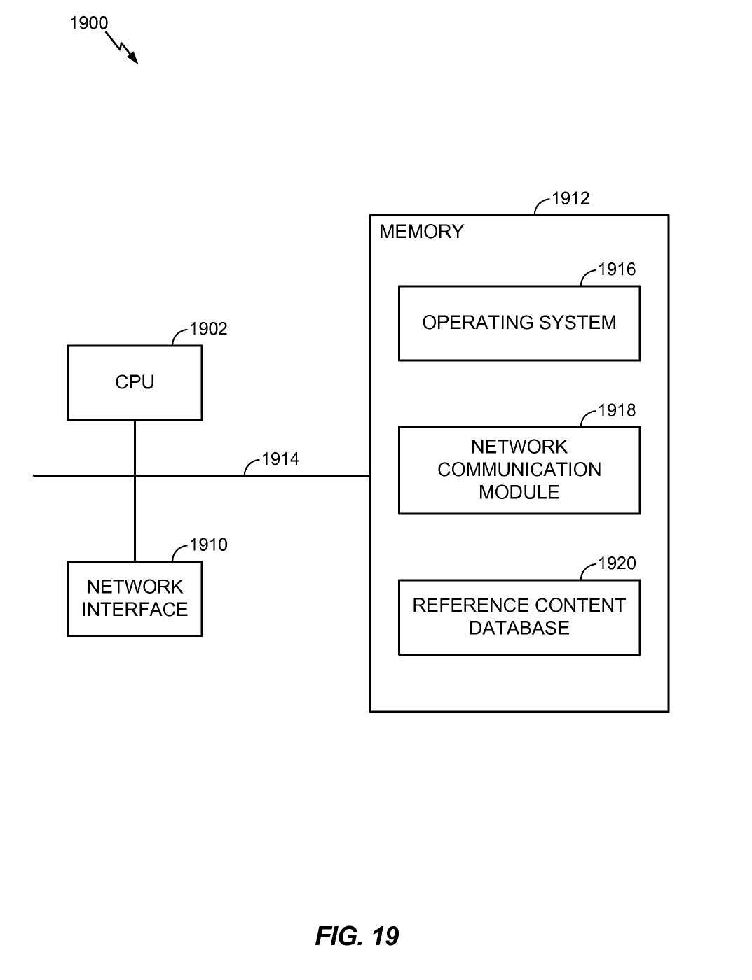

FIG. 19 is a block diagram illustrating a server system 1900, which may be any one of the servers previously described, for providing in real-time video and audio content tags of a plurality of channel programs to a display device implemented in accordance with some embodiments. The server system 1900 may include one or more processing units (CPU's) 1902, one or more network or other communications network interfaces, a memory 1912, and one or more communication buses 1914 for interconnecting these components. The server system 1900 may also include a user interface (not shown) having a display device and a keyboard.

The memory 1912 may be any suitable memory, such as a high-speed random access memory, (e.g., DRAM, SRAM, DDR RAM or other random access solid state memory devices). The memory 1912 may include or may alternatively be non-volatile memory (e.g., one or more magnetic disk storage devices, optical disk storage devices, flash memory devices, or other non-volatile solid state storage devices). In some embodiments, the memory 1912 may include one or more storage devices remotely located from the CPU(s) 1902 and/or remotely located in multiple sites.

Any one of the above memory devices represented by the memory 1912 may store any number of modules or programs that corresponds to a set of instructions for performing and/or executing any of the processes, operations, and methods previously described. For example, the memory 1912 may include an operating system 1916 configured to store instructions that includes procedures for handling various basic system services and for performing hardware dependent tasks. A network communication module 1918 of the memory 1912 may be used for connecting the server system 1900 to other computers via the one or more communication network interfaces 1910 (wired or wireless) and one or more communication networks, such as the Internet, other wide area networks, local area networks, metropolitan area networks, and so on.

The memory 1912 may also include a reference content database configured to include a video fingerprint database, an audio fingerprint database, a facial feature database, a voice model database, an object database, background sound database, an acoustic model database, a facial model database, an object model database, and the like. Each of the databases in the reference content database may be used for determining content information that may be included in a content tag for a channel program. The operating system 1916 may update the reference content database 1920 with video and audio contents in multimedia signal streams received from a plurality of content providers through the network communication module 1918. The operating system 1916 may also provide the content tag for the video and audio contents to a plurality of display devices via the network communication module 1918.

In general, any device described herein may represent various types of devices, such as a wireless phone, a cellular phone, a laptop computer, a wireless multimedia device, a wireless communication personal computer (PC) card, a PDA, an external or internal modem, a device that communicates through a wireless channel, etc. A device may have various names, such as access terminal (AT), access unit, subscriber unit, mobile station, mobile device, mobile unit, mobile phone, mobile, remote station, remote terminal, remote unit, user device, user equipment, handheld device, etc. Any device described herein may have a memory for storing instructions and data, as well as hardware, software, firmware, or combinations thereof.

The techniques described herein may be implemented by various means. For example, these techniques may be implemented in hardware, firmware, software, or a combination thereof. Those of ordinary skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, the various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

For a hardware implementation, the processing units used to perform the techniques may be implemented within one or more ASICs, DSPs, digital signal processing devices (DSPDs), programmable logic devices (PLDs), field programmable gate arrays (FPGAs), processors, controllers, micro-controllers, microprocessors, electronic devices, other electronic units designed to perform the functions described herein, a computer, or a combination thereof.

Thus, the various illustrative logical blocks, modules, and circuits described in connection with the disclosure herein are implemented or performed with a general-purpose processor, a DSP, an ASIC, a FPGA or other programmable logic device, discrete gate or transistor logic, discrete hardware components, or any combination thereof designed to perform the functions described herein. A general-purpose processor may be a microprocessor, but in the alternate, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in software, the functions may be stored on or transmitted over as one or more instructions or code on a computer-readable medium. Computer-readable media include both computer storage media and communication media including any medium that facilitates the transfer of a computer program from one place to another. A storage media may be any available media that can be accessed by a computer. By way of example, and not limited thereto, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Further, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc, where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein are applied to other variations without departing from the spirit or scope of the disclosure. Thus, the disclosure is not intended to be limited to the examples described herein but is to be accorded the widest scope consistent with the principles and novel features disclosed herein.

Although exemplary implementations are referred to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices may include PCs, network servers, and handheld devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be appreciated that the above identified modules or programs (i.e., sets of instructions) need not be implemented as separate software programs, procedures or modules, and thus various subsets of these modules may be combined or otherwise re-arranged in various embodiments. Furthermore, the memory 1912 may store additional modules and data structures not described above.

What is claimed:

1. A method of providing a channel program recommendation in real-time for a display device, the method comprising:
receiving a plurality of multimedia signal streams for a plurality of channel programs;
generating in real-time at least one video and audio content tag based on at least one of video and audio contents from the multimedia signal streams;
generating the channel program recommendation, wherein the channel program recommendation includes at least one of the channel programs based on the at least one video and audio content tag and at least one of a plurality of viewing criteria; and
outputting a notification of the channel program recommendation.

2. The method of claim 1, wherein generating the channel program recommendation comprises:
ordering the channel programs as the channel program recommendation based on the at least one of the viewing criteria.

3. The method of claim 2, further comprising prioritizing the viewing criteria based on at least one viewing preference and a viewing history.

4. The method of claim 1, wherein the at least one video and audio content tag comprises at least one of a performer, an event, and a sound.

5. The method of claim 4, wherein the performer is recognized by at least one of a face recognition analysis and a voice analysis.

6. The method of claim 4, wherein the event is recognized by a scene analysis.

7. The method of claim 4, wherein the sound includes at least one of music, a song, a voice, a speech, a conversation, and a news report.

8. The method of claim 7, wherein the music is recognized by an audio fingerprint analysis.

9. The method of claim 7, wherein a singer of the song is recognized by a voice analysis.

10. The method of claim 7, wherein the speech, the conversation, or the news report is recognized by at least one of a voice analysis and a speech analysis.

11. The method of claim 1, wherein outputting the notification comprises:
detecting an external device capable of receiving the notification; and
transmitting the notification to the external device.

12. The method of claim 1, wherein outputting the notification comprises displaying the channel program recommendation on the display device.

13. The method of claim 1, wherein outputting the notification comprises:
performing a face recognition to determine whether a predetermined facial feature is detected in a viewable area of the display device;
detecting an external device associated with the predetermined facial feature and capable of receiving the notification if the predetermined facial feature is not detected; and
transmitting the notification to the external device.

14. A system for providing a channel program recommendation in real-time comprising:
a server configured to receive a plurality of multimedia signal streams and generate in real-time at least one video and audio content tag based on at least one of video and audio contents of a plurality of channel programs from the multimedia signal streams; and
a display device configured to generate the channel program recommendation,
wherein the channel program recommendation includes at least one of the channel programs based on the at least one video and audio content tag received from the server and at least one of a plurality of viewing criteria.

15. The system of claim 14, wherein the server is further configured to generate the at least one video and audio content tag of the plurality of the channel programs at a predetermined time interval, and transmit the at least one video and audio content tag to the display device.

16. The system of claim 15, wherein the display device is further configured to update the channel program recommendation based on the received at least one video and audio content tag and the plurality of the viewing criteria.

17. The system of claim 14, wherein the display device is further configured to output a notification of the channel program recommendation.

18. A display device for providing a channel program recommendation comprising:
a channel program recommendation unit configured to receive at least one video and audio content tag for a plurality of channel programs from a server, and generate the channel program recommendation, wherein the channel program recommendation includes at least one of the channel programs based on the at least one video and audio content tag and at least one of a plurality of viewing criteria; and
a display unit configured to output a notification of the channel program recommendation.

19. The display device of claim 18, wherein the channel program recommendation unit is further configured to:
identify the at least one of the channel programs based on whether the at least one video and audio content tag includes at least one of the viewing criteria; and
ordering the identified channel programs as the channel program recommendation based on the at least one of the viewing criteria.

20. The display device of claim 19, further comprising prioritizing the at least one of the viewing criteria based on at least one viewing preference and a viewing history.

21. The display device of claim 18, further comprising a communication unit configured to detect an external device capable of receiving the notification, and transmit the notification to the external device.

22. The display device of claim 18, wherein the display unit is further configured to display the channel program recommendation.

23. The display device of claim 18, further comprising:
an imaging sensor configured to capture an image in a viewable area of the display device; and
a communication unit configured to detect an external device capable of receiving the notification,
wherein the channel program recommendation unit is further configured to perform a face recognition to determine whether a predetermined facial feature is detected in the captured image, the predetermined facial feature being associated with the external device, and
wherein if the channel program recommendation unit does not detect the predetermined facial feature, the channel program recommendation unit transmits the notification to the external device.

24. A server for providing at least one video and audio content tag for a plurality of channel programs to a display device, the server comprising:
a receiving unit configured to receive a plurality of multimedia signal streams for the plurality of channel programs; and
a channel analysis unit configured to generate in real-time the at least one video and audio content tag based on at least one of video and audio contents from the multimedia signal streams, and to output the at least one video and audio content tag to the display device.

25. The server of claim 24, wherein the channel analysis unit is further configured to recognize at least one of a performer, an event, and a sound for the at least one video and audio content tag.

26. The server of claim 25, wherein the performer is recognized by at least one of a face recognition analysis and a voice analysis.

27. The server of claim 25, wherein the event is recognized by a scene analysis.

28. The server of claim 25, wherein the sound includes at least one of music, a song, a voice, a speech, a conversation, and a news report.

29. The server of claim 28, wherein the music is recognized by an audio fingerprint analysis.

30. The server of claim 28, wherein a singer of the song is recognized by a voice analysis.

31. The server of claim 28, wherein the speech, the conversation, or the news report is recognized by at least one of a voice analysis and a speech analysis.

32. A display device for providing a channel program recommendation in real-time, the display device comprising:
means for receiving at least one video and audio content tag for a plurality of channel programs from a server;
means for generating the channel program recommendation, wherein the channel program recommendation includes at least one of the channel programs based on the at least one video and audio content tag and at least one of a plurality of viewing criteria; and
means for outputting a notification of the channel program recommendation.

33. The display device of claim 32 further comprising:
means for generating in real-time the at least one video and audio content tag based on at least one video and audio contents from multimedia signal streams for the plurality of channel programs.

34. The display device of claim 32, wherein the means for generating the channel program recommendation comprises:
means for identifying the at least one of the channel programs based on whether the at least one video and audio content tag includes at least one of the viewing criteria; and
means for ordering the identified channel programs as the channel program recommendation based on the at least one of the viewing criteria.

35. The display device of claim 34, further comprising means for prioritizing the at least one of the viewing criteria based on at least one viewing preference and a viewing history.

36. The display device of claim 32, further comprising:
means for detecting an external device capable of receiving the notification, and transmitting the notification to the external device.

37. The display device of claim 32, wherein the means for outputting the notification comprises means for displaying the channel program recommendation.

38. The display device of claim 32, further comprising:
means for capturing an image in a viewable area of the display device; and
means for detecting an external device capable of receiving the notification,
wherein the means for generating the channel program recommendation comprises means for performing a face recognition to determine whether a predetermined facial feature is detected in the captured image, the predetermined facial feature being associated with the external device, and
wherein if the predetermined facial feature is not detected, the notification is transmitted to the external device.

39. A server for providing at least one video and audio content tag for a plurality of channel programs to a display device, the server comprising:
means for receiving a plurality of multimedia signal streams for the plurality of channel programs;
means for generating in real-time the at least one video and audio content tag based on at least one of video and audio contents from the multimedia signal streams; and
means for outputting the at least one video and audio content tag to the display device.

40. The server of claim 39, wherein the at least one video and audio content tag comprises at least one of a performer, an event, and a sound.

41. The server of claim 40, wherein the performer is recognized by at least one of a face recognition analysis and a voice analysis.

42. The server of claim 40, wherein the event is recognized by a scene analysis.

43. The server of claim 40, wherein the sound includes at least one of music, a song, a voice, a speech, a conversation, and a news report.

44. The server of claim 43, wherein the music is recognized by an audio fingerprint analysis.

45. The server of claim 43, wherein a singer of the song is recognized by a voice analysis.

46. The server of claim 43, wherein the speech, the conversation, or the news report is recognized by at least one of a voice analysis and a speech analysis.

47. A non-transitory computer-readable storage medium comprising instructions for providing a channel program recommendation in real-time on a display device, the instructions causing a processor of the display device to perform the operations of:
receiving at least one video and audio content tag for a plurality of channel programs from a server;
generating the channel program recommendation, wherein the channel program recommendation includes at least one of the channel programs based on the at least one video and audio content tag and at least one of a plurality of viewing criteria; and
outputting a notification of the channel program recommendation.

48. The medium of claim 47, wherein generating the channel program recommendation comprises:
identifying the at least one of the channel programs based on whether the at least one video and audio content tag includes at least one of the viewing criteria; and
ordering the identified channel programs as the channel program recommendation based on the at least one of the viewing criteria.

49. A non-transitory computer-readable storage medium comprising instructions for providing at least one video and audio content tag for a plurality of channel programs to a display device, the instructions causing a processor of a server to perform the operations of:
receiving a plurality of multimedia signal streams for the plurality of channel programs;
analyzing in real-time at least one of video and audio contents from the multimedia signal streams;
generating the at least one video and audio content tag for the channel programs; and
outputting the at least one video and audio content tag to the display device.

50. The medium of claim 49, wherein the at least one video and audio content tag comprises at least one of a performer, an event, and a sound.
